(19) United States
(12) Patent Application Publication
(10) Pub. No.: US 2009/0138552 A1
(43) Pub. Date: May 28, 2009

(54) APPARATUS AND METHOD FOR MANAGING COMMUNICATION BETWEEN PARTIES

(75) Inventors: David Johnson, Elmsworth (GB); Anthony Waters, Maidenhead (GB); William Hern, Reading (GB); John Storrie, Maidenhead (GB)

Correspondence Address: BARNES & THORNBURG LLP, P.O. BOX 2786, CHICAGO, IL, 60690-2786, US

(73) Assignee: NORTEL NETWORKS LIMITED, St. Laurent (CA)

(21) Appl. No.: 11/944,814

(22) Filed: Nov. 26, 2007

(51) Int. Cl. G06F 15/16

(52) U.S. Cl. 709/204

(57) ABSTRACT

A communication system having a user input arranged to receive data from a user, an information input arranged to receive information about another user and a rule server. The rule server being arranged to store a rule that initiates communication between the user and the another user when the communication system receives information about the another user. The information relating to trigger information specified by the user.

### FIELD OF THE INVENTION

This invention relates to apparatus and methods for managing communications between parties. The invention is applicable for use in enabling a user to configure when communication is initiated by themselves to another user.

### BACKGROUND OF THE INVENTION

Communication systems that enable a user to control how and when they can be contacted are known. For example, a system may allow a user to specify that they are unavailable at the current time or do not want to be contacted during the hours of 1200 and 1400. Alternatively, a user may specify what method another user can contact them by, for example, whether it is by cellular phone, fax, email, a land line telephone or any other means.

However, entering this detail can be time consuming and require a knowledge of programming languages which a user typically does not have. Additionally, there is no way for a caller to use the information in the presence management system to facilitate a call they wish to make to a user connected to the presence management system.

### SUMMARY OF THE INVENTION

In accordance with a first aspect of the present invention there is provided a communication system in communication with a first endpoint and a second endpoint; the communication system configured to receive a rule from the first endpoint, the rule identifying the second endpoint, status relating to the second endpoint and a type of communication, and, upon receipt of notification that the second endpoint has the identified status cause the communication to occur between the first and second endpoint.

The status may be selected from a list of status's registered with the communication system.

Preferably, the communication system includes an input to receive a registration message, the registration message including what values the field can take and how the status is to be compared to status in a rule. The registration message may be an XML message.

Optionally, the status may be related to one of the group comprising: presence information, location information and scheduling information.

The notification relating to status may be received from a source external to the communication system and the communication type is selected from a list of communication type's registered with the communication system.

The rule may be arranged to initiate communication only within a predetermined period of time or if no communication has been initiated during the predetermined period of time. The period of time may terminate a predetermined period of time after creation of the rule or occur between a first and second time specified by the user.

Optionally, the notification of a change of status may relate to two or more changes in any of the group comprising: location information, presence information and schedule information.

The communication may be one of the group comprising, a telephone call, an email and an instant message initiated from a terminal of the user to a terminal of the another user.

The communication may be initiated between a plurality of users when the users have the identified status. Preferably the communication is initiated between the plurality of users when at least a predetermined number of the plurality of users have the identified status.

The rule is stored in a database connected to the communication system.

In accordance with another aspect of the present invention there is provided a method of initiating communication between a first endpoint and a second endpoint using a communication system in communication with the first endpoint and the second endpoint; the communication system receiving a rule from the first endpoint, the rule identifying the second endpoint, status relating to the second endpoint and a type of communication, and, upon receipt of notification that the second endpoint has the identified status causing the communication to occur between the first and second endpoint.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 illustrates a network in which the present invention can be implemented;

FIG. 2 is a schematic diagram of the present invention; and

FIG. 3 illustrates the rule builder of the present invention.

### DETAILED DESCRIPTION OF PREFERRED EMBODIMENTS

### System Overview

The communication system is designed to facilitate communication between two or more endpoints.

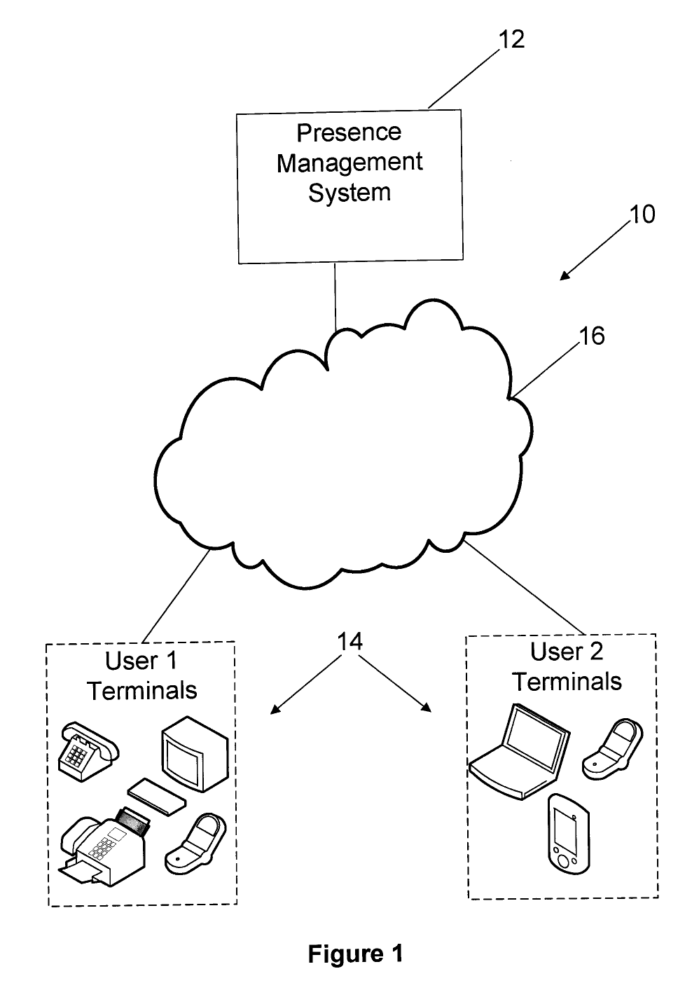

FIG. 1 illustrates a network 10 including a communication system 12. The communication system 12 is arranged to facilitate communication between two or more user terminals 14. Each user terminal 14 is associated with a user that is registered with the communication system 12. Each user may be associated with more than one user terminal 14, for example, in FIG. 1 the end points associated with user 1 are a land line telephone, a facsimile machine, and a computer, and the end points associated with user 2 are a land line telephone, a cellular telephone, and a computer.

The user terminals are arranged so that they can transmit data to and receive data from the communication system 12. This may be achieved by a direct connection between the communication system and end point or, as shown in FIG. 1, indirectly via one or more networks 16. The connections may be any type of connection suitable for transmitting data between the user terminals and communication system 12.

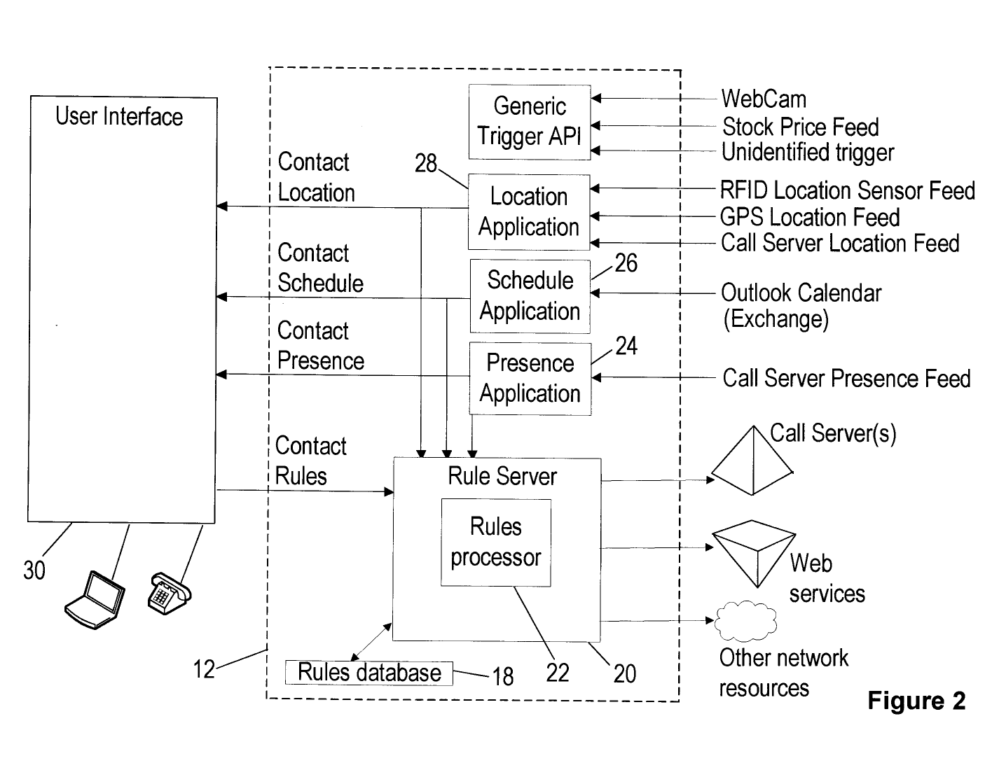

The communication system 12 of the present invention and its interactions with external devices is illustrated in FIG. 2. The communication system 12 includes one or more databases which store information relating to users registered with the communication system 12. Examples of databases the communication system may include are a billing database (not shown) which stores billing information and a contact database (not shown) which stores information regarding contact numbers for users. The database set-up will be well known to one skilled in the art.

### User Information

A user wishing to use the communication system should register with the system. Preferably, during registration a user transmits personal data such as their name, address and billing details to the communication system. The user also transmits contact data relating to each user terminal with which he is associated.

A registered user can customise their presence on the communication system 12 by specifying contact rules. The data is stored in the appropriate database. Contact rules are used to control communication between one or more users and can, for example, determine how and when a user can be contacted on each user terminal.

Contact rules are stored on a rules database 18 in the communication system 12. The rules database 18 may be individual or alternatively combined with another database. Contact rules include, for example, how a user can be contacted, for example a rule may specify that a call to the user's cellular telephone will not be connected during particular hours.

In addition to a user creating a contact rule specifying how they can be contacted, a user may also create a contact rule specifying when they wish to contact another user. For example, a user may create a contact rule specifying that when a certain user logs off from a user terminal a telephone call is initiated between the users. These contact rules are also stored in the rules database.

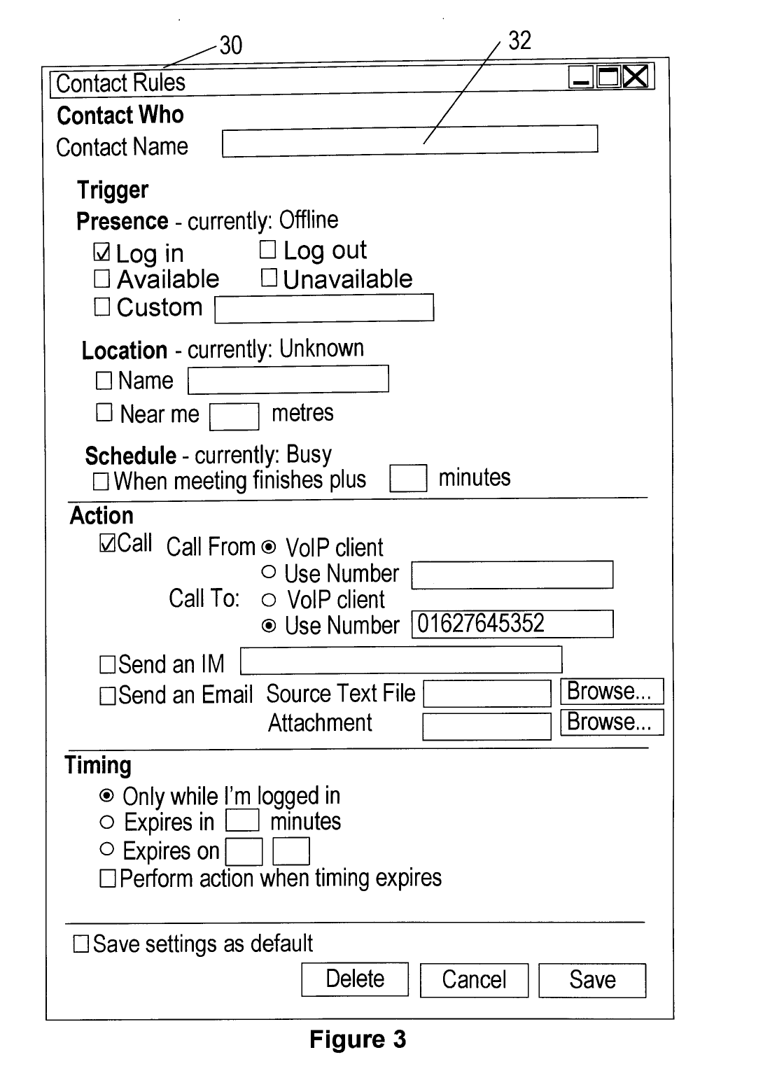

A user may use a form 30 such as that illustrated in FIGS. 2 and 3 to generate one or more rules to be added to the rules database. Referring to the form 30 illustrated in FIG. 3. A form 30 is displayed using an application on the user interface of a user terminal, for example, the display monitor of a computer. In the form 30 the user identifies any users that are to be included in the contact rule.

To identify a user, the name of the user may be entered onto the form 30, for example by typing a user identifier into a box 32. In this instance the communication system can use any rules in the rules database to control the method by which the identified user is contacted.

The user may also specify the conditions under which communication between the users is to be initiated. A condition may be, for example, one or more changes in state of a user specified in a contact rule. For example, a change in presence, such as a user logging in or out of a user endpoint or a user turning on or turning off an endpoint such as a cellular telephone. Other types of conditions may be specified and these can include the presence of a user in a certain location or the beginning or end of an appointment in a scheduler such as Microsoft Outlook.

If desired, the user may specify conditions which do not relate to the user specified in the contact rule. These conditions also have to be met before the communication is initiated between users. For example, the user may require that they are logged on to a particular user terminal before any communication with another user is initiated.

Additionally, the user may specify on the form a period when the rule is ‘active’. When the rule is active the conditions specified in the contact rule being complied with initiates communication between the users in the rule. Conversely, when the rule is not active no communication is initiated between users regardless of whether the conditions specified in the contact rule are complied with or not.

The period may be defined as being between, for example 1200 and 1400 hours. Alternatively, the period may state a duration of time, e.g. that the rule deactivates in half an hour. Additionally, the user may specify that the rule is only to be activated on the day that it is created or it may be activated recurrently, for example every Friday or every Friday for a month.

Preferably, the user specifies the type of communication they wish to initiate when the conditions are satisfied. For example, a user may specify that they wish a call between the users to be set up or, alternatively, an email or instant message to be sent to a user. When the user specifies that a call is initiated when the conditions are satisfied, the user may specify which of their terminals is to be used to make the communication. The user may also select which user terminal they want the communication to be made to.

Optionally, if more than one user terminal associated with the user can receive the communication type, for example a land line and a cellular telephone, the user may use the form to indicate the order in which connection with the user terminals should be attempted.

The user may also specify a list of actions to be taken when the conditions specified are satisfied. For example, that a telephone call should be made to a specific cellular telephone, and if the cellular telephone is not answered, a text message should be sent to the cellular telephone.

Optionally, if desired the user can specify a type of communication to be made when the contact rule transfers from an active to an inactive state. For example, they may want to have an email sent to a user endpoint to inform the user that they were trying to contact them.

When the user has completed the form 30 it is transmitted from the endpoint to the communication system. The communication system then causes the contact rule to be stored in the rule database.

Preferably, the contact rules are created using an XML document.

Returning to FIG. 2, the rules database 18 is connected to a rules server 20 which includes a rules processor 22 and controls the implementation of the rules stored within the rules database 18. The rules server 20 may be located at the same location as the communication system or, alternatively, implemented separately on individual user terminals. The databases for the communication system may be located on the communication system 12 or alternatively, may be implemented on a separate piece of hardware connected to the communication system 12.

### Feed Data

The communication system includes one or more feed inputs. The input is configured to receive metadata specifying events. Feeds are registered with the rules server with a description of the feeds contents being provided to the rules server. Preferably, the description of the feeds contents is a metadata describing each of the fields present and how they should be compared to a contact rule.

An example of metadata received as XML used to register a feed with the rules server is shown below:

```
<profile>
    <name>presence</name>
    <origin>UserID@adomain.com</origin>
    <contents>
        <sequence name=“fields”>
            <field name=“availability”>
                <type>Boolean</type>
                <compare>Boolean</compare>
                <display>String</display>
            </field>
            <field name=“presence“>
                <type>presence_values</type>
                <compare>presence_values</compare>
                <display>String</display>
            </field>
        </sequence>
    </contents>
    <simpleType name=“presence_values“>
        <restriction base=“String“>
            <xs:enumeration value=“Available”/>
            <xs:enumeration value=“Busy”/>
            <xs:enumeration value=“On the phone”/>
            <xs:enumeration value=“Be right back”/>
        </xs:restriction>
    <xs:simpleType>
</profile>
```

In the metadata example above the type of feed is specified as presence. This means that it is an event regarding a user logging in/out of a user terminal. The origin identifies the user that is the source of the event.

The metadata specifies that each event from the feed will contain two fields, other than the source field. These are ‘availability’ and ‘presence’. Each field includes the following elements: Type—the values the field can include; Compare—describes how the rules server should allow a user to set a condition using the form when setting up a contact rule. How the rules server compares the field to the contact rules and how the rules server causes the field to be presented on the form 30 to the user.

As can be seen from the example, the availability field specifies the type field using a Boolean descriptor that is set as true or false depending on whether a user is available or not. The compare field is also Boolean and a user can set true or false criteria against this field in a contact rule, and the rule server compares the field as a Boolean descriptor.

In a comparable way the Presence field specifies the type field as a locally defined type defining an enumeration of presence values and controls the presence values that can be reported. The rules server compares the field in a received feed to the relevant part of the contact rule as presence_values enumeration.

Once a feed is registered with the system the relevant fields are displayed on the form 30 and can form part of a contact rule.

The communication system can then receive feeds having information relating to that registered with the rules server, in this case availability and presence. Upon receipt of a feed input the data is transmitted to one of a plurality of applications. The applications may include, but are not limited to: a presence application 24, a schedule application 26, a location application 28, a clock or other timing device (not shown) and any other desired application. Each application may be co-located on the rules server or may be situated on separate servers.

The presence application 24 processes information relating to the presence, or a change in presence, of a user in the system that is received by the communication system using the meta data as described above. Presence meta data may be received by the communication system, for example, when a user logs onto a user terminal or when a user terminal becomes available for communication e.g. is turned on.

The schedule application 26 is adapted to receive metadata related to a users schedule. For example, meta data relating to information in a diary, calendar or equivalent, on one or more of the user endpoints. For example, it may record when the user enters a meeting and when the end time of the meeting occurs.

The location application 28 processes meta data relating to the geographical location of a user. The information may, for example, be received from a call server, a GPS or RFID location sensor, a trigger device on a door, chair or other piece of furniture, or any other device able to provide information on the location of a user.

Feed inputs may be received from any other suitable source and when a new feed source registers with the communication system it provides information relating to the meta data in the same way as described above. One other source of feed data are plug-ins or trigger applications such as a web service or a camera arranged to transmit information to the communication system if movement is detected.

Feed data that is received by the communication system is transmitted within the communication system to the appropriate application, for example metadata relating to presence or availability may be transmitted to the presence application. The presence application transmits a message to the rule processor describing the event which has occurred.

The rules server then compares the data received to the data in contact rules in the manner defined in the compare field in the meta data used to register the feed. The rules server on identifying any rules which have conditions satisfied by the feed data will transmit messages to endpoints to cause any actions specified in the contact rule to occur.

Alternatively, each application may be provided with a descriptor of a rule that is initiated by a change related to that application. For example, the presence application may include a list of rules which are initiated by a change in presence or availability on the network. The list preferably includes a description of the change in presence identified in the rule. The presence application, upon receiving information regarding a change in presence, identifies rules associated with the notified change of presence and transmits identifiers for the associated rules to the rules server. The rules server can then implement the rules if all the conditions in the contact rules are met. In this way only a subset of rules need to be examined in response to feed data, rather than all the rules present on the communication system.

### Actions

As discussed above when a feed notifies the communication system of an event checks to see whether the event is associated with any contact rules. If there is no contact rule associated with the event that the meta data can be discarded and no further action taken.

Alternatively, if a contact rule is associated with the event then a rule server acts to process the rule by determining whether all the conditions associated with the contact rule are satisfied, e.g. all users having a cellular telephone presence with the communication system. If not all the conditions are satisfied then no further action is taken.

If all the conditions identified in the contact rule are satisfied, however, then the users are identified and the communication system transmits messages to one or more of the user endpoints specified in the contact rule to cause the type of communication specified in the contact rule to occur. For example, the communication system may cause one user endpoint to send an e-mail to another endpoint or cause a telephone connection to be initiated between two or more user endpoints.

The response caused by the communication system to all the conditions in a contact rule being satisfied will be referred to as an action. As described previously the user can specify which actions are taken using the form 30.

For a user to select an action the action must first be registered with the rules server via the Action Register application. To register the action meta data describing the action must be supplied to the rule server in a similar manner to the feed registration described above.

An example of metadata using XML for registering an action for making a call on the rules database is shown below:

```
<profile>
    <name>make_call</name>
    <type>WSDL</type>
    <service>http://somewhere/makecall</service>
    <contents>
        <sequence name=“fields“>
            <origin>UserId@adomain.com</origin>
            <field name=“calling_party“>
                <type>URI</type>
            </field>
            <filed name=“called_party“>
                <type>URI</type>
            </field>
        </sequence>
    </contents>
</profile>
```

In this metadata the name element must be unique for each type of action. The type field describes the type of action that is to be taken when the rule is satisfied. For example in this case WSDL is identified which will cause a web service to initiate the call. The service element provides the address/endpoint to which the action event should be sent and the contents specify fields that are required in order to complete the action, for example the details for the calling and called parties. If desired a further element may be included that specifies how to determine if an action was successfully completed.

When a new action is registered with the contact management system the form 30 may be adapted in order that the new action can be selected by users that are building contact rules.

When the communication system receives a feed the rules server then identifies the contact rules whose conditions are now satisfied. Each of these contact rules will contain actions in the format shown above which will be activated by transmitting messages to the relevant party. For example, if the contact rule includes the action rule described above then it will send a message to the WDSL to cause a call to be set up between the endpoints identified in the contacts rule.

### Use of System

One example of the communication system in use is given below. User 1 wishes to talk to user 2 by telephone but user 2's cellular telephone is off. Therefore, User 1 loads a form onto their computer to cause the communication to control communication between the two users. User 1 also identifies that they wish to set up communication between their landline and user 2's cellular telephone, but if no contact an be established with their landline telephone then contact with their cellular telephone should be attempted. User 2 is to be contacted when user 2's cellular telephone is connected to the communication system. User 1 also specifies that the rule is active between 1700 and 1900 hours.

The form as completed by User 1 is transmitted to the communication system which stores the rule in the data base, transmits a rule identifier and the descriptor of the change of user 2 logging on the system using their cellular phone to the presence application.

If User 2 turns on their cellular phone at 1815 hours, the cellular phone sends feed data to the communication system indicating its presence. The input forwards the data to the presence application which scans any rules associated with the presence change. The presence application then transmits a message to the rule server including the rule identifier and indicating that user 2 has turned on their cellular telephone. The rule server then causes the rule processor to examine the rule to ensure all conditions in the rule are satisfied. If they are then the rule server causes a call to be set up between the landline and cellular telephones for user 1 and user 2 respectively.

If user 2 does not switch on their cellular telephone between the hours of 1700 hours and 1900 hours then the rule server causes the rule to be deleted from the communication system such that the presence server does not notify the rule server when user 2 turns on their cellular telephone. Hence, if user 2 turns on their cellular phone at 1915 hours then no call is set up between user 1 and User 2 as the rule is not active.

If desired a user may specify that an action occurs on expiry of the rule. For instance, in the rule specified above, user 1 could specify that user 2 is sent a text message if they run on their cellular phone after 1900 hours.

If desired a single feed could cause multiple actions to occur. For example one user logging on may cause a call being made to one user and an email being sent to a second user informing them that the first user is free. Additionally, the rule may be dependent upon multiple users, for example if a conference call is being set up a user may wish to specify a group of users to be connected to the same call when all the participating users are logged on.

The skilled person will understand that the user terminals suitable for user with the present invention are not limited to those mentioned herein and not all user terminals available to a user need to be registered with the communication system.

A user may specify that communication with more than one user is initiated when the conditions of the contact rule are met. This enables the user to set up a conference call for example. The user may also specify that only a certain number of the users they have specified are available for the conference call to be initiated or that the conference call is initiated when certain users are available regardless of the presence of the other users identified in the contact rule.

If desired the rules server may be adapted to carry out the functions of the applications described above and no separate presence, location, schedule etc. . . . applications may be provided.

By providing the ability to register feeds and actions using XML the rule server does not need to understand the content of the feed or the action as the metadata describing the feeds content controls the way that the rules server compares the feed with the contact rules. In a similar way the action meta data controls the messages that the rules server transmits to set up communications.

Additionally, the use of XML allows new types of feed and actions to be readily added to the communication system. There is therefore no limitation on the type of feed or actions that can be specified by a user.

What is claimed is:

1. A communication manager comprising:
i) a first input arranged to receive a communication rule from a first endpoint, the rule identifying a second endpoint, status relating to the second endpoint and a type of communication;
ii) a second input arranged to receive data, the data including a notification message comprising status information for the second endpoint:
iii) processing means arranged to determine, upon receipt of the notification message, if the status information matches the status in the rule and cause a connection between the first and second endpoint according to the type of communication specified in the communication rule if the status information matches the status in the communication rule.

2. A communication manager as recited in claim 1 including a status database arranged to store information relating to status.

3. A communication manager as recited in claim 2 wherein the communication manager includes:
i) an input arranged to receive an endpoint registration message, the registration message including status values and the at least one status rule specifying how the status is to be compared to status in a communication rule;
ii) a recorder arranged to store the status values and the at least one status rule in the status database.

4. A communication manager as recited in claim 3 wherein the registration message is an XML message.

5. A communication manager as recited in claim 2 wherein the status is related to one of the group comprising: presence information, location information and scheduling information.

6. A communication manager as recited in claim 1 including a communication database arranged to store information relating to communication types.

7. A communication manager as recited in claim 6 wherein the communication manager includes:
i) an input to receive a communication registration message, the communication registration message including communication type and information on how the communication type is to be initiated; and
ii) a recorder arranged to store the communication type values and information on how the communication type is to be initiated in the communication database.

8. A communication manager as recited in claim 7 wherein the communication registration message is an XML message.

9. A communication manager as recited in claim 1 wherein the notification message includes information determining how the communication system compares the status in the notification message to the status in a communication rule.

10. A communication manager as recited in claim 1 wherein the communication rule is arranged to initiate communication only within a predetermined period of time.

11. A communication manager as recited in claim 10 wherein the communication rule initiates communication if no communication has been initiated during the predetermined period of time.

12. A communication system as recited in claim 10 wherein the period of time terminates a predetermined period of time after creation of the communication rule.

13. A communication system as recited in claim 10 wherein the period of time occurs between a first and second time specified by the user.

14. A communication system as recited in claim 1 wherein the communication type comprises one of the group comprising, a telephone call, an email and an instant message initiated from a terminal of the user to a terminal of the another user.

15. A communication system as recited in claim 1 wherein communication is initiated between a plurality of users when the users have the status indicated in the communication rule.

16. A communication system as recited in claim 15 wherein communication is initiated between the plurality of users when at least a predetermined number of the plurality of users have the status indicated in the communication rule.

17. A method for initiating communication between a first endpoint and a second endpoint using a communication manager; the method including the steps of:
i) the communication manager receiving a communication rule from the first endpoint, the rule identifying the second endpoint, status relating to the second endpoint and a type of communication;
ii) the communication manager receiving data including a notification message comprising status information for the second endpoint
iii) the communication manager determining, upon receipt of the notification message, if the status information matches the status in the rule; and
iv) the communication manager causing a connection between the first and second endpoint according to the type of communication specified in the communication rule if the status information matches the status in the communication rule.

18. A computer program on a computer readable medium arranged to cause a communication manager in a network including a first endpoint and a second endpoint to perform the steps of:
i) receive a communication rule from the first endpoint, the rule identifying the second endpoint, status relating to the second endpoint and a type of communication;
ii) receive data including a notification message comprising status information for the second endpoint
iii) determine, upon receipt of the notification message, if the status information matches the status in the rule; and
iv) cause a connection between the first and second endpoint according to the type of communication specified in the communication rule if the status information matches the status in the communication rule.
